(19) United States
(12) Patent Application Publication
(10) Pub. No.: US 2010/0252410 A1
(43) Pub. Date: Oct. 7, 2010

(54) Water Purification Device and Method

(76) Inventor: Frederick William Millar, Healesville Victoria (AU)

Correspondence Address: DONN K. HARMS;PATENT & TRADEMARK LAW CENTER, SUITE 100, 12702 VIA CORTINA, DEL MAR, CA, 92014, US

(21) Appl. No.: 12/608,910

(22) Filed: Oct. 29, 2009

(30) Foreign Application Priority Data
Apr. 1, 2009 (AU) 2009901343

(51) Int. Cl. C02F 1/04; B01D 3/02

(52) U.S. Cl. 203/11; 202/185.1; 202/195; 202/166

(57) ABSTRACT

A water purification system for saltwater or otherwise polluted water. The system employs one or a plurality of tower like structures formed of a plurality of engaged modular individual boilers. Increased energy efficiency is obtained using rising heat from lower situated boilers in a communication with above situated modular boilers, through a channel surrounding the exterior of the stacked modular boilers. Incoming water is thereby subjected to a super heating process to render it potable and collected on exiting the top of the stacked modular boilers.

### BACKGROUND OF THE INVENTION

1. Field of the Invention

This application claims priority to Australian Provisional Patent Application Number 2009901343 filed on Apr. 1, 2009, and respectively incorporated herein in its entirety by reference.

The present invention relates to purification of water. More specifically, the device disclosed herein, relates to an easily employed device and method for purification of water through heat and distillation which is generally modular in construction and increases efficiency through the employment of stacked modular boilers enabling each boiler sequentially elevated above the last, to increase efficiency by the communication of heat from boilers below through the provision of a unique chimney system.

2. Prior Art

As aptly stated by the World Heath Organization, clean water is a basic human right, and without it societies wither and die. Additionally noted was the fact that in excess of one billion people have no reliable supply of fresh water for drinking and sanitation. As populations increase the world will continue to confront an every more critical shortage of clean water for increasing world inhabitants. This shortage is particularly acute in third world countries such as in Africa and Asia.

Of note, with the increasing lack of fresh water available to populations, there is a continually increasing amount of contaminated water present which might be converted to fresh water. Such contamination is generally caused by natural and agricultural run off and by the employment of fresh water in sewage systems. An additionally available potential fresh water source, in countries with seashore, is the abundance of salt water that might be treated to render it potable.

Additionally, as the world's population continues to increase, the unmet demand for fresh water, will be increasingly severe, especially in arid and semiarid regions which may be affected by the climate change. As noted above, salt water, brackish water, sewage contaminated water, and other water containing solids and contaminants are potential available sources of fresh water. Numerous such technologies exist for conversion of these underused potential sources of fresh water. Such conventional systems employ diverse technologies such as reverse osmosis, evaporation, and vapor compression. However, these conventional prior art methods of desalination of salt water and/or purification of brackish water and sewage contaminated water are not well adapted for employment in countries which lack a technologically educated population as well as the energy required to operate purification devices.

In a conventional purification using a distillation processes, or filtering through reverse osmosis, there is a particularly limiting factor for poorer countries due to the high operational costs associated with heating water to produce steam, or running pumps to produce pressures to use filters in reverse osmosis.

In order to kill pathogens found in polluted water, such as sewage or similarly polluted water, it requires a heating of the water to a temperature of at least 171 deg Centigrade. This temperature must be reached and held in order to transform polluted waters and sewage widely found in third world countries in order to render the water potable by killing all the pathogens therein.

Reverse osmosis, on the other hand, will not work at the high temperatures required to kill pathogens and is run at ambient temperatures. As such, reverse osmosis processing units will generally not provide a guarantee that the filtering process has rendered the water free of potentially dangerous pathogens. As a consequence, reverse osmosis is ill prepared to produce bottled drinking water from sewage contaminated waters that abound in most countries.

Because of the high energy requirements of these systems, and with the ever rising cost of energy prices, the cost becomes a key factor in the production of potable water and a severely limiting factor in poor countries unable to afford the means to produce the energy for heat or pumping of water purification systems.

Another used mode of purification has been exposure of water to ultra violet light. However, UV light can be ineffective should the water being treated have particulate or solids therein which shield organisms and therefore is not dependable.

Conventional reverse osmosis systems, while very effective with brackish water and especially with purification of salt water, require massive pumps to create operational pressures to force the water through filtration units. Consequently this technology is generally employed only in countries with the ability to fund the operational electrical costs to provide electrical energy to the pumps providing the pressure to filter the water.

Additionally, desalination of salt water, as the water is purified, salt concentration for downstream components and filters, cause severe scaling of filtration systems and other components of the system. Particulate, when purifying brackish or sewage contaminated water similarly, must be removed from equipment and filters. Over time, this results in frequent maintenance requirements for the conventional systems requiring the replacement of filtering elements in pressure systems and the cleaning of components and conduits in heat-based systems. In areas of the world with a population which is both uneducated and poor, these operational costs dictated by high maintenance prohibit the employment of most such systems.

Therefore, there is a continuing need for a method and apparatus for water purification and/or desalination which is highly efficient, inexpensive to operate, and requires infrequent maintenance. Such a system should be able to produce the super heated steam required for both elimination of pathogens in sewage tainted water as well as to eliminate salt from salt water. Such a system should require maintenance which is simplified to a point where operators with minimal education can perform it. Such a system should be highly efficient in its use of energy during processing to thereby be employable in countries with low incomes and minimal energy resources.

### SUMMARY OF THE INVENTION

The water purification and desalinization device herein disclosed and described provides a unique and novel solution to the noted shortcomings of the prior art. The water purification system herein, is adaptable for required water output through the employment of modular components that may be assembled into towers which are assembled into a cluster of towers each of which intakes polluted or salt water and outputs clean water. Still further, taking advantage of the unique boilers and stacking thereof together, with the utilization of a steam anomaly, the disclosed system is capable of producing temperatures in excess of 170 degrees centigrade which, as noted, is required to generate super heated steam for treatment of sewage, other tainted and salt water, to render them potable. The steam however is produced at very low costs for energy due to the unique stacked configuration of the boilers, heating chambers and the steam anomaly.

The device enabling the method of subjecting incoming water to a super heating process to render it potable, employs this plurality of boilers with each boiler having internal heating chambers that are provided with an internal thermostatically controlled refrigerated device to control the rate of condensation in the said heating chambers that form the towers. Each of the towers is constructed of these boilers with modular heating chambers in this stacked configuration which when assembled, provides a chimney effect of upwards flow of both the produced super heated steam, and the heat employed to create the steam in individual heating chambers. The steam is produced by a spraying of a mist of preheated water into the heated chambers, that may be initially filtered water, to remove larger solids.

The water is preheated to substantially 98 to 100 degrees Centigrade in a heat exchanger, a temperature that will rapidly create steam of the fine mist of water that is subsequently injected into each pre-heated chamber in a downwardly projected conical mist designed so that mist molecules do not contact the inner side surfaces of the heating chambers, thus minimizing the accumulation of solids on the walls and obviating the need to frequently clean said walls.

The steam in each stacked heating chamber, in a sequentially stacked group of boiler modules forming a tower, rises inside the heating chamber forming a central portion of the boilers, and escapes through slots or apertures communicating through the top surface of the heating chamber and into a chimney or surrounding chamber positioned between the sidewalls of each heating chamber and a secondary casing forming the exterior wall of the boiler and surrounding the sidewall which defines each individual heating chamber.

Upon the exterior of each of the sidewalls forming the heating chamber, of each stacked boiler, and positioned within the chimney formed by the surrounding chamber around each of the stacked heating chambers, is an electric heating element. Since the steam from lower-positioned heating chambers is always rising through the overhead surrounding chamber in which the heating element is positioned, the steam provides a means to heat the sidewalls of heating chambers positioned overhead, thereby reducing the amount of electricity required by the electrical element.

The element must heat the individual heating chambers in the tower substantially to 120 degrees Centigrade to allow for any minor heat loss caused by the incoming mist of preheated water, yet will still allow the heating chambers to reach temperatures sufficient to produce steam heat.

By stacking the heating chambers sequentially one on top of the other, preferably employing three or more of the modular boilers, a chimney effect causes all of the super heated steam produced by the plurality of heating chambers of the boilers, to rise to a steam collector positioned at the distal end of the tower, formed by the stacked boilers. To gain an additional benefit provided by an economy of scale of multiple towers operating in unison, a plurality of towers formed of modular boilers is positioned in a circular fashion and concurrently engaged to a centrally located heat exchanger.

The steam created by the downwardly projected mist in each heating chamber is directed to impact a thermostatically controlled cooling device that regulates the amount of steam required to condense and release latent heat, to raise the internal temperature of a heating chamber, to be well in excess of 171 deg. centigrade which is a temperature known to be sufficient to kill all living organisms and remove any toxic chemicals that may be present in water being treated.

As the regulated portion of steam condenses, it radiates heat as lost energy, which experimentation has shown, will raise the internal temperature in the heating chamber of each boiler to substantially in excess of 200 degrees Centigrade.

Sensors adapted to monitor the temperature in each of the heating chambers, formed in each of the modular boilers, to control the heat created by the condensing anomaly, will adjust the electrical power provided to the electrical element surrounding the sidewalls of the boilers within the surrounding chamber of the chimney. The heat output of the electrical element will be adjusted to maintain a temperature in each heating chamber of each boiler at a level adapted to turn the mist pumped into the chamber into super heated steam. The heat from the rising steam is then re-captured by the sidewalls of above-located boilers, thereby greatly reducing the electrical energy required for the system.

Due to the probable locations of the device herein being in harsh and third world locations, maintenance is a prime concern. Because the water being injected into the boilers contains salt or fluidized particulate, residue will tend to form on the interior of the stacked boilers.

Maintenance for the removal of such residue is minimized by the provision of a removable base plate forming the floor or bottom surface of each heating chamber of each boiler. The base plate also doubles as the top for each of the boilers in the Heating Chamber stack. With exception of the top boiler in the stack, which is fitted with a fixed top plate. This base plate is in a slidable engagement through an aperture in the sidewall of the boiler which acts as a scraper to remove all sediment and residue on each plate when slid from its engagement with a boiler. This scraping of the plate may be activated simultaneously in all heating chambers in the stack or progressively working upwardly from the bottom Heating Chamber. This mechanical action provides a means to scrape off the waste residue collected on the base plates of all Heating Chambers at once and allow the residue to fall through the stack to a positioned hopper or conveyor provided under the lower heating chamber ready for disposal. Removal of the plates will also allow easy access to the interior of the boilers for maintaining the surfaces and cleaning.

For large scale desalination plants and the like, the volume of residue may require that the base plates be activated sequentially, commencing at the bottom Heating chamber.

Means to prevent residue from forming on the interior surfaces of the sidewall forming the heating chamber of each boiler is provided by formation of the mist in a manner wherein it does not touch the sidewall before turning to steam. Any solids within the liquid being sprayed will travel for a short period before being released as the mist turns to steam allowing gravity to direct the solids to the bottom of the boiler.

A frusto conical housing surrounding the mist sprayer may be employed to aid in that mist formation. Consequently, using this mist projection limitation provides additional means to ensure that, little or no residue forms upon the interior surface of the sidewall forming each heating chamber of each boiler thereby minimizing maintenance.

Still further, a means to prevent corrosion of the electrical heating element is provided by the locating of the heating element inside the surrounding passage forming the chimney. This is because the heating element is never exposed to saltwater or to any particulate from the polluted or brackish water sprayed into the heating chamber. Thus the possible corrosion from the highly corrosive salt water, or particulate contained in polluted water, never reaches the element where it may act to corrode it.

The bottom boiler in each of the stacked modular boilers will have the surrounding chamber space filled with an insulating material such as fiberglass. Additionally, a cap will be provided to block off the top aperture of the surrounding chamber thereby adapted in design to cause any water created by condensation, if the plant is turned off for any reason, to fall within the heating chamber of the bottom-positioned boiler in the tower where it can either be allowed to escape, via the base plate, or just boiled off when the plant is back in operation.

Additional improvement in energy efficiency is provided by communicating the steam from the exit apertures of the uppermost boiler in each stack forming each tower to a heat exchanger. The heat exchanger is thermally engaged to impart heat from the steam into the incoming water forming the mist in each boiler thereby reducing energy requirements to heat the incoming water before misting it.

Optionally, a portion of the steam rising within the stacked surrounding chambers of the modular boilers forming each tower may be directed to drive a turbine. This turbine would then be employed to provide electrical current to run or partially run the electrical heating element. If excess power is available, it may be sold to the grid operator or used locally if the system is located in an area of the world lacking electrical power.

Water exiting the central conduit from the heat exchanger is exceptionally clean and potable and may be piped from the heat exchanger to a storage tank. Condensation of the steam to water, when running through the heat exchanger, is aided by the cooling effect from the incoming water to the mist generators.

The disclosed device and method herein, provide additional cost and operational savings over conventional devices for purification and desalinization. Currently employed systems yield brine byproducts reaching between 48 to 50% of the total liquid communicated through the system. These byproducts must be disposed of which is an expensive and time-consuming process. Disposal of such byproducts is severely restricted by most government regulations if disposed of in a land fill. Should the large quantity of brine byproducts be piped out for disposal at sea, there is significant cost since the capital costs of piping and pumps combined with the ongoing costs of pumping add to the cost of the final product. Over time, the outlet for such piping systems must be relocated due to the toxicity of the salt around the outlet and its deadly effect on aquatic life forms. Consequently the increased costs continue for the life of conventional plant operations.

Consequently, a major benefit yielded by the disclosed device and method is the very small amount of dry brine which is more easily disposed of than conventionally noted above brine which tends to be larger in quantity and of higher water content. The device and method herein, form a brine byproduct of substantially 2% of the total throughput of liquid entering the system. This minimal byproduct production greatly decreases initial and long term costs noted above of conventional plants by the significant reduction in brine residues which must be pumped or transported to the ocean or landfills.

With respect to the above description, it is to be understood that the invention is not limited in its application to the details of construction and to the arrangement of the components in this specification or illustrated in the drawings showing the water purification device and method herein. The device and method herein described providing a novel apparatus and method for energy efficient water purification is capable of other embodiments and of being practiced and carried out in various ways which will be obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed water purification and desalinization device.

It is important, therefore, that the claims and disclosure herein be regarded as including any such equivalent construction and methodology insofar as they do not depart from the spirit of the present invention.

It is an object of this invention to provide a water purification device and method which is modular in nature and capable of assembly to structures matching required production using standardized assembleable modules and components.

An additional object of this invention is the provision of a water purification system and method which is highly energy efficient allowing purification and desalinization using minimal energy and thereby minimizing energy costs.

A further object of this invention is the provision of a device and method for water purification and/or desalination which employs components which are low maintenance and easily serviced by operators having minimal education.

These together with other objects and advantages which become subsequently apparent, reside in the details of the construction and operation as herein described with reference being had to the accompanying drawings forming a part thereof, wherein like numerals refer to like parts throughout.

### BRIEF DESCRIPTION OF DRAWING FIGURES

FIG. 1 shows a perspective view of a grouping of modular boiler components operatively engaged to form a stacked water purification and desalinization plant.

FIG. 2 is a graphic depiction of a sectional view of a single stacked desalinization and purification tower along line 3-3 of FIG. 1.

FIG. 3 depicts a sectional view along line 3-3 of FIG. 1, of an assembled plant for water purification and desalinization.

FIG. 4 is a sectional view of stacked heating chambers showing the communicating chimney conduits of each and clean water exhaust housing topping the most elevated heating chamber.

FIG. 5 depicts a bottom perspective view of a single modular heating chamber having a sliding plate forming a bottom surface of the chamber.

FIG. 6 depicts an overhead perspective view of the top of FIG. 5, in a typical modular heating chamber showing the cylindrical side wall forming the interior heating chamber between the engaged sliding plate and top surface.

### DETAILED DESCRIPTION OF PREFERRED EMBODIMENTS

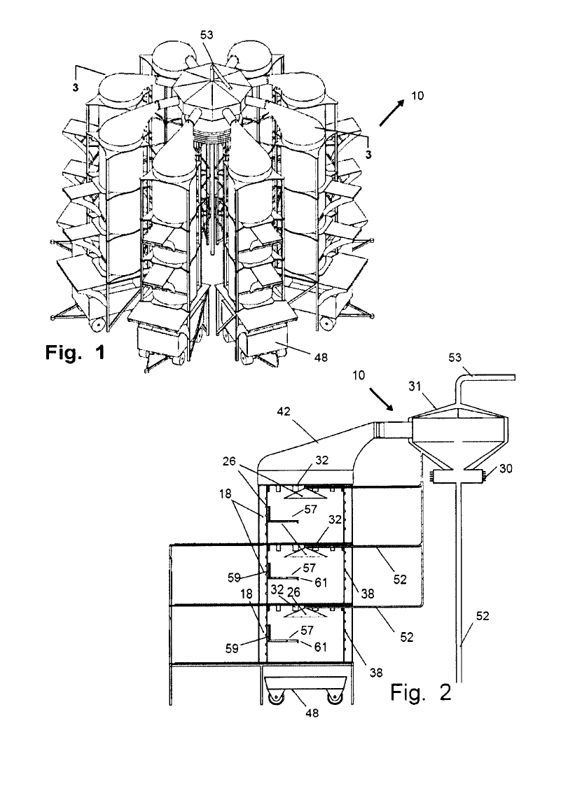

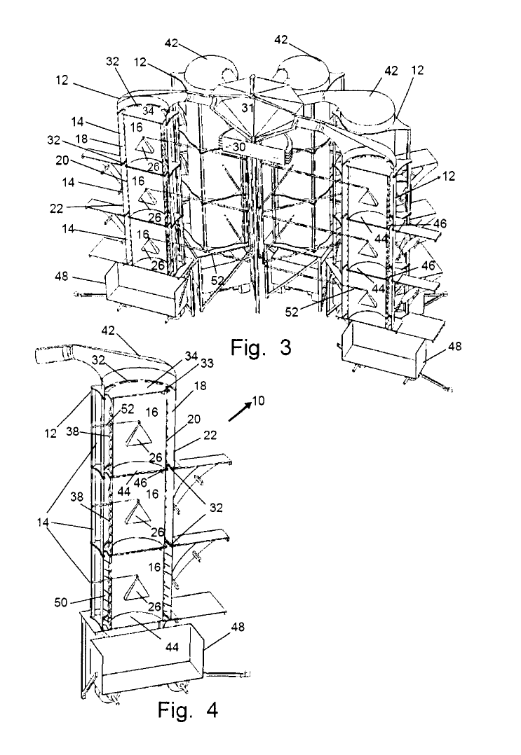

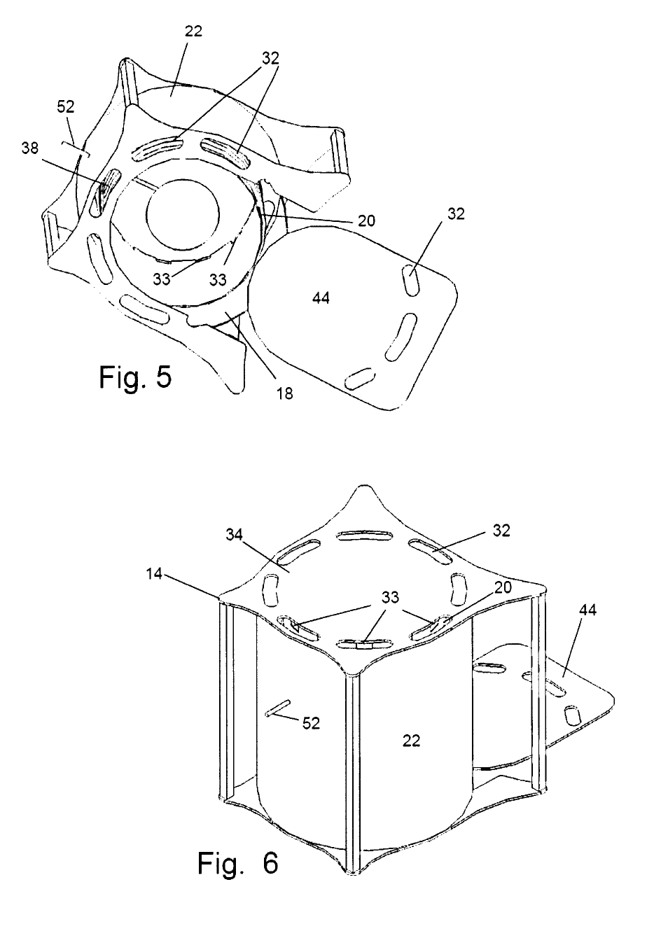

Referring now to the drawings, FIGS. 1-6 show components of the modular water purification or desalinization device 10 individually and assembled various preferred modes. Similar parts are identified by like reference numerals which may be found in one or more of the drawings.

The device 10 forms the water purification plant of FIG. 1 through the formation and operative connection of a plurality of towers 12 each formed of a plurality of stacked boilers 14. Each of the towers 12 is constructed a plurality of the boilers 14 with each having centrally positioned heating chambers 16. The towers 12 in this stacked configuration formation, have a surrounding chamber 18, positioned between the sidewalls 20 of each heating chamber 16, and a secondary casing 22 forming the exterior wall of the boiler 14. The surrounding chamber 18 thus surrounds the sidewall 20 defining each individual heating chamber 16.

This configuration is particularly preferred in that it produces a chimney effect of upwards flow of both the produced super heated steam from each heating chamber 16, and also the heat employed to create the steam in individual heating chambers 16 and the lower located surrounding chamber 18.

In the preferred mode of the system, steam is produced by a spraying of a mist 26 of seawater or initially filtered water to remove larger solids. The water is preheated to substantially 98 to 100 degrees Centigrade in a heat exchanger 30, and subsequently sprayed in a downwardly projected preferably conical mist 26. The mist 26 so injected into the pre-heated heating chamber 16, instantly turns to steam which is then increased in temperature to super heated steam in heating chamber 16 to a temperature able to kill pathogens as well as to remove salt substantially upon entering the chamber 16.

The superheated steam in each stacked heating chamber 16, rises and escapes through slots or apertures 33 communicating through the upper portion of the sidewall 20 adjacent to the top surface 34 of the heating chamber 16. The apertures 33 communicate with the surrounding chamber 18 positioned between the sidewall 20 forming each heating chamber 16 and a secondary casing 22 forming the exterior wall of the boiler and surrounding the sidewall 20 which defines each individual heating chamber 16.

As can be seen in FIGS. 4-6, upon the exterior of each of the sidewalls 20 forming the heating chamber 16 is positioned an electric heating element 38. Since the steam from lower positioned heating chambers 16 continually rises through the overhead surrounding chamber 18 in which the heating element 32 is positioned, the incoming steam from the apertures 33 communicating with a lower-positioned heating chamber 16, provides a means to preheat the sidewalls 20 of heating chambers 16 positioned overhead. The heating elements 38 combine with the incoming steam to heat the individual heating chambers 16 in the tower to substantially around 120 degrees Centigrade to allow for any minor heat loss caused by the incoming mist 26 of preheated water.

By stacking the boilers 14 with their heating chambers 16 sequentially, in addition to heating overhead boilers, a chimney effect causes the super heated steam produced by the plurality of heating chambers 16 to rise to a steam collector 31 positioned at the uppermost end of the tower formed by the stacked boilers 14. Additional energy gain is provided by an economy of scale of multiple towers operating in unison a circular fashion and concurrently engaged to warm the centrally located heat exchanger 30.

The steam created by the downwardly projected mist 26 in each heating chamber may be directed toward a cooling component 57 having a distal end generally in a central area of the heating chamber 16 of the boiler 14. A cooling occurs from steam contacting the cooling component 57 as shown in FIG. 2, causing a portion of steam to condense inside the heating chamber 16 which concurrently radiates heat as lost energy. This condensation releasing heat provides means to raise an internal temperature in the heating chamber 16 of each boiler to substantially to 200 degrees centigrade.

Means to monitor heating chamber 16 temperature, may be provided by electronic or mechanical sensors adapted to monitor the temperature in each of the heating chamber 16. Based on the temperature in the chamber 16 imparted by the lost heat from the condensation, the sensor will adjust the current to the heating element 38 to use only the energy needed to reach the proper temperatures inside the chamber at a level adapted to turn the mist 26 into super heated steam. The heat from the rising steam is then recaptured by the sidewalls 20 of above-located boilers 14, thereby reducing the electrical energy required for the system greatly.

Water being injected into the boilers 14 may generally contains salt or fluidized particulate. Upon changing to steam, because of the designed spray pattern, little residue will tend to form on the interior wall surfaces of the heating chambers 16 of the boilers.

Means to easily remove such residue is provided by the base plate 44 forming the floor or bottom surface of each heating chamber 16 of each boiler 14. This plate 44 is engaged in a slidable engagement through an aperture 46 in the sidewall 20 of the boiler 14. Translating the plate 44 toward the exterior of the boiler 14 causes the edge of the aperture 46 to act as a scraper to remove all sediment and residue on each plate. This combined scraping of the plates 44 provides a means to remove the residue which falls down to a hopper 48 or if the plates 44 are removed successively from the bottom upwards the sediment will fall sequentially to the hopper 48 located at the bottom of the tower formed by the stack of modular boilers 14 where it may be removed by the positioned hopper 48 or conveyer or the like. Removal of the plates 44 also will allow personnel to enter the boilers 14 to maintain the interior surfaces.

Additional minimization of maintenance is provided, by formation of the mist 26 to project within the heating chamber 16 in a manner wherein it does not touch the sidewall 20 before turning to steam, residue is minimized. A housing surrounding the mist sprayer may be employed to aid in that mist 26 formation.

The cooling component 57 may be employed to cause the condensation noted above and energy relief. Still further, maintenance is also minimized by locating the heating element 38 inside the surrounding passage 18 forming the chimney. This eliminates exposure of the heating element 38 to any residue which is left in the chamber 16. As the disclosed device employs a pioneering use of latent heat from the condensing steam, the method of controlling the amount of steam needed to be condensed to produce the heat transferring effect is variable. So the cooling component 57 in one preferred mode will be built into the boiler 14 and employed adjustably depending on the amount of steam needed to be reduced in temperature to below 100 c. to effect the necessary cooling to release the heat. The component 57 may take the form of a refrigerator pipe 59 with a sensor probe 61 on a distal end electrically connected to a control for the refrigeration or other means to initiate the cooling to the cooling component 57. The refrigerator pipe 59 may enter into the chamber 16 at an upper point and runs part way down the side of the chamber 16 and then to a central position as depicted in FIG. 2.

The base or bottom boiler 14 in each of the stacked modular boilers 14 will have the surrounding passage 18 space which is filled with an insulating material 50 such as fiberglass as depicted in FIG. 4. A cap is provided to cover the top of the insulation material to prevent steam or condensed moisture from the chimney 18 getting into the insulation. The cap also directs any condensation that may collect in the bottom of chimney 18 through apertures 32, of the bottom boiler for removal as previously described.

The modular construction of the device 10 provides exceptional utility should a boiler 14 be in need of repair or replacement. Unlike conventional boiler systems which need to be generally turned off for weeks or more, and laboriously repaired or replaced, the device herein provides great utility in its modular formation. In the event of a boiler module malfunction, should time not permit, since the stacked boiler 14 modules all communicate steam upward in the surrounding passage 18, the errant boiler 14 may simply be turned off and the remainder of boiler modules will function. If time permits, the errant boiler module in any given stack may easily be replaced with one that functions, by removing the errant boiler module from its position and inserting a functioning boiler module in its place.

Additional improvement in energy efficiency is provided by ducting the steam from the exit apertures 32 of the uppermost boiler 14 in each stack forming each tower to a heat exchanger 30 engaged to a condensing chamber 31.

The heat exchanger is thermally engaged to impart heat from the steam into the incoming water in pipes 52 to form the mist 26 in each boiler 14 thereby reducing energy requirements to heat the incoming water before misting it.

Water exiting the central conduit from the heat exchanger 30 is exceptionally clean and potable and may be piped from the heat exchanger to a storage tank. Additionally, employing vent 53, provision is made, in accordance with the disclosed device 10, to allow any volatile organic chemicals present, which boil at a lower temperature than water, and turn into a gas within the heating chamber, such as Benzene, to be vented to atmosphere or captured by a conventional scrubber device required by many chemical industries and the like. This action prevents any impurities from collecting in the distillate or potable water.

While all of the fundamental characteristics and features of the water purification and desalinization system and method herein have been shown and described, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art, without departing from the spirit or scope of the invention. Consequently, all such modifications and variations and substitutions as will certainly occur to those skilled in the art on reading this disclosure, are included within the scope of the invention as defined by the following claims.

What is claimed is:

1. A water purification apparatus comprising:
a plurality of boilers in a stack, said stack substantially defining a tower;
said tower having a first end positionable above a mounting surface, and having a distal end opposite said first end;
each said boiler in said stack having a heating chamber defined by a vertically disposed sidewall, a first endwall, and a second endwall situated overhead of said first endwall;
a casing surrounding said sidewall and extending between said first endwall and said second endwall;
a void substantially surrounding said sidewall between said casing and said sidewall;
first apertures communicating between said heating chamber and said void, said first apertures positioned adjacent to said second sidewall;
secondary apertures communicating through said second endwall, said secondary apertures providing communication between respective said voids surrounding respective said heating chambers of said boilers in said stack;
a heating element positioned in said void adjacent to said sidewall of each of said boilers in said stack;
means to inject a mist of water into each said heating chamber;
said heating element providing a first means to heat said heating chamber to a temperature adapted for a formation of steam from said mist;
said formation of steam providing means to separate dissolved solids from said water;
a communication of said steam through said first apertures of said heating chamber to said void and said distal end of said tower, providing secondary means to heat respective said sidewalls of overhead situated said boilers;
means for capture of said steam exiting said distal end; and
means to cool said steam communicated from said means for capture of said steam to form water therefrom.

2. The water purification apparatus of claim 1, additionally comprising:
said means to inject said mist configured to form said mist in a pattern, said pattern sized for an avoidance of a contact with said sidewall; and
said avoidance providing means to prevent formation of a residue of said dissolved solids upon said sidewall.

3. The water purification apparatus of claim 1, additionally comprising:
said means to cool said steam being a heat exchanger; and
said heat exchanger providing means to preheat said water communicated to said means to inject said mist of water.

4. The water purification apparatus of claim 2, additionally comprising:
said means to cool said steam being a heat exchanger; and
said heat exchanger providing means to preheat said water communicated to said means to inject said mist of water.

5. The water purification apparatus of claim 1, additionally comprising:
said second endwall of each lower-positioned said boiler in said stack, also forming said first endwall of an above-positioned boiler in said stack;
each said second endwall being slidably engaged through an aperture in said sidewall and moveable from an engaged position, separating adjacent said heating chambers, to a translated position whereby a communication between said adjacent said heating chambers is formed; and
movement from said engaged position to said translated position causing a dislodgement of residue of said dissolved solids on said second endwall and a communication of said residue to a respective said heating chamber of said lower-positioned said boiler, whereby said residue from all respective said heating chambers in said stack may be communicated to a container on said support surface by concurrent or sequential positioning of said respective endwalls to said translated position.

6. The water purification apparatus of claim 2, additionally comprising:
said second endwall of each lower-positioned said boiler in said stack, also forming said first endwall of an above-positioned boiler in said stack;
each said second endwall being slidably engaged through an aperture in said sidewall and moveable from an engaged position, separating adjacent said heating chambers, to a translated position whereby a communication between said adjacent said heating chambers is formed; and
movement from said engaged position to said translated position causing a dislodgement of residue of said dissolved solids on said second endwall and a communication of said residue to a respective said heating chamber of said lower-positioned said boiler, whereby said residue from all respective said heating chambers in said stack may be communicated to a container on said support surface by concurrent or sequential positioning of said respective endwalls to said translated position.

7. The water purification apparatus of claim 3, additionally comprising:
said second endwall of each lower-positioned said boiler in said stack, also forming said first endwall of an above-positioned boiler in said stack;
each said second endwall being slidably engaged through an aperture in said sidewall and moveable from an engaged position, separating adjacent said heating chambers, to a translated position whereby a communication between said adjacent said heating chambers is formed; and
movement from said engaged position to said translated position causing a dislodgement of residue of said dissolved solids on said second endwall and a communication of said residue to a respective said heating chamber of said lower-positioned said boiler, whereby said residue from all respective said heating chambers in said stack may be communicated to a container on said support surface by concurrent or sequential positioning of said respective endwalls to said translated position.

8. The water purification apparatus of claim 4, additionally comprising:
said second endwall of each lower-positioned said boiler in said stack, also forming said first endwall of an above-positioned boiler in said stack;
each said second endwall being slidably engaged through an aperture in said sidewall and moveable from an engaged position, separating adjacent said heating chambers, to a translated position whereby a communication between said adjacent said heating chambers is formed; and
movement from said engaged position to said translated position causing a dislodgement of residue of said dissolved solids on said second endwall and a communication of said residue to a respective said heating chamber of said lower-positioned said boiler, whereby said residue from all respective said heating chambers in said stack may be communicated to a container on said support surface by concurrent or sequential positioning of said respective endwalls to said translated position.

9. The water purification apparatus of claim 3, additionally comprising:
a plurality of said towers surrounding said heat exchanger;
each of said plurality communicating said steam to said heat exchanger; and
said heat exchanger providing said means to heat said water communicated to said heating chambers of each of said plurality of towers, whereby an increased energy efficiency is provided by said plurality of towers each communicating said steam to said heat exchanger.

10. The water purification apparatus of claim 4, additionally comprising:
a plurality of said towers surrounding said heat exchanger;
each of said plurality communicating said steam to said heat exchanger; and
said heat exchanger providing said means to heat said water communicated to said heating chambers of each of said plurality of towers, whereby an increased energy efficiency is provided by said plurality of towers each communicating said steam to said heat exchanger.

11. The water purification apparatus of claim 3, additionally comprising:
a vent communicating from an upper surface of said heat exchanger; and
said vent providing means to separate vaporized organic chemicals present in said steam, from said steam.

12. The water purification apparatus of claim 4, additionally comprising:
a vent communicating from an upper surface of said heat exchanger; and
said vent providing means to separate vaporized organic chemicals present in said steam, from said steam.

13. The water purification apparatus of claim 7, additionally comprising:
a vent communicating from an upper surface of said heat exchanger; and
said vent providing means to separate vaporized organic chemicals present in said steam, from said steam.

14. The water purification apparatus of claim 8, additionally comprising:
a vent communicating from an upper surface of said heat exchanger; and
said vent providing means to separate vaporized organic chemicals present in said steam, from said steam.

15. The water purification apparatus of claim 9, additionally comprising:
a vent communicating from an upper surface of said heat exchanger; and
said vent providing means to separate vaporized organic chemicals present in said steam, from said steam.

16. The water purification apparatus of claim 3, additionally comprising:
a vent communicating from an upper surface of said heat exchanger; and
said vent providing means to separate vaporized organic chemicals present in said steam, from said steam.

17. The water purification apparatus of claim 3, additionally comprising:
a probe communicating through said sidewall at a first end and extending into a distal end at a central portion of said heating chamber;
said probe engaged to a means to regulate a probe temperature of said probe;
said probe temperature being adapted to cause a portion of said steam to condense within said heating chamber; and
said portion so condensing providing a means to release and radiate heat from said steam, to said sidewall within said heating chamber.

18. The water purification apparatus of claim 4, additionally comprising:
a probe communicating through said sidewall at a first end and extending into a distal end at a central portion of said heating chamber;
said probe engaged to a means to regulate a probe temperature of said probe;
said probe temperature being adapted to cause a portion of said steam to condense within said heating chamber; and
said portion so condensing providing a means to release and radiate heat from said steam, to said sidewall within said heating chamber.

19. A method of converting brackish or polluted water to potable water employing the apparatus of claim 3, comprising:
employing said heating element as said first means to heat said heating chamber for a duration of time adapted to heat said heating chamber to said temperature adapted for a formation of steam from said mist;
communicating under pressure, said brackish or polluted water to a conduit communicating through said heating chamber and with each said means to inject a mist of water into each said heating chamber;
allowing said steam to form in each said heating chamber and to rise and communicate through said first apertures into said void;
allowing said steam to rise in said void to and exit at said distal end, and to concurrently heat each overhead respective said sidewall between its communication through said first apertures and said distal end;
communicating said steam from said distal end through said heat exchanger where it converts to said potable water; and
capturing said potable water exiting said heat exchanger.

20. A method of converting brackish or polluted water to potable water employing the apparatus of claim 4, comprising:
employing said heating element as said first means to heat said heating chamber for a duration of time adapted to heat said heating chamber to said temperature adapted for a formation of steam from said mist;
communicating under pressure, said brackish or polluted water to a conduit communicating through said heating chamber and with each said means to inject a mist of water into each said heating chamber;
allowing said steam to form in each said heating chamber and to rise and communicate through said first apertures into said void;
allowing said steam to rise in said void to and exit at said distal end, and to concurrently heat each overhead respective said sidewall between its communication through said first apertures and said distal end;
communicating said steam from said distal end through said heat exchanger where it converts to said potable water; and
capturing said potable water exiting said heat exchanger.
